(19) United States
(12) Patent Application Publication
(10) Pub. No.: US 2026/0028092 A1
(43) Pub. Date: Jan. 29, 2026

(54) GEARSHIFT DEVICE AND ASSOCIATED MOBILITY DEVICE

(71) Applicant: VALEO EMBRAYAGES, Amiens Cedex 2 (FR)

(72) Inventors: Martina GUIDI, Mondovi (IT); Andrea CANTELLA, Mondovi (IT); Gianmarco LOMUSCIO, Mondovi (IT); Massimo CIMA, Mondovi (IT); Matteo SPAGNOLO, Mondovi (IT); Alfio AIRALDI, Mondovi (IT)

(73) Assignee: VALEO EMBRAYAGES, Amiens Cedex 2 (FR)

(21) Appl. No.: 19/278,078

(22) Filed: Jul. 23, 2025

(30) Foreign Application Priority Data
Jul. 25, 2024 (FR) FR2408267

(51) Int. Cl. B62M 25/08; B62M 6/55

(52) U.S. Cl. CPC B62M 25/08; B62M 6/55

(57) ABSTRACT

A gearshift device for a mobility device includes a selection shaft in which there are housed a shuttle and a worm, three input pinions configured so as to turn freely around the selection shaft, and three output pinions that rotate as one with a hollow shaft. A gearshift actuator is arranged so as to displace the shuttle along the worm between three positions and to engage a selected gear ratio. The device includes at least a series of three pawls positioned one after another along the longitudinal axis of the selection shaft, each pawl being associated with a lifter device allowing the pawl to be lifted by the shuttle and engage the gear ratio selected via the input and output pinions.

The present invention relates to the field of gearshift devices and more particularly to a gearshift device for a mobility device using at least electrical propulsion and, for example, to an electrically assisted bicycle.

When a mobility device is in operation, a motive force is transmitted to the wheels via a crank system turning about an axis of a crankset that drives the rear wheel, generally via a chain.

Gearshift devices for mobility devices are already known from the prior art. These gearshift devices comprise a gearbox in which a shuttle is configured such that, as it moves, it positions itself under a pinion of a selected gear ratio, and engages this gear ratio via a pawl. Such a device requires numerous parts. It is complex to manufacture and to service.

The object of the present invention is therefore to overcome one or more of the disadvantages of the devices of the prior art by proposing a simplified transmission assembly for a mobility device.

For that reason, the present invention proposes a gearshift device for a mobility device, comprising:
a selection shaft in which there are housed a shuttle and a worm,
three input pinions configured so as to turn freely around the selection shaft,
three output pinions that rotate as one with a hollow shaft,
a gearshift actuator arranged so as to displace the shuttle along the worm between three positions and to engage a selected gear ratio,
   the device comprising at least a series of three pawls positioned one after another along the longitudinal axis of the selection shaft, each pawl being associated with a lifter device allowing the pawl to be lifted by the shuttle and engage the gear ratio selected via the input and output pinions.

Such a number of pawls allows the device to be optimized.

According to one embodiment of the invention, the gearshift device comprises two series of three pawls positioned one after another along the longitudinal axis of the selection shaft.

According to one embodiment of the invention, the series of pawls are arranged 180 degrees from each other around the selection shaft.

According to one embodiment of the invention, the device comprises a radial blocking system, formed as a single piece, to hold all of the pawls in place on the selection shaft.

According to one embodiment of the invention, the blocking system is formed of a longitudinal flat part from which there extend three tabs, each of the tabs being positioned above one of the pawls.

According to one embodiment of the invention, the device comprises three input pinions and output pinions, three pawls and three tabs.

According to one embodiment of the invention, the radial blocking system comprises a positioning tab.

The invention also relates to a mobility device, notably an electrically assisted mobility device, having a gearshift device according to the invention.

According to one embodiment of the invention, the device is an electrically assisted bicycle. Further aims, features and advantages of the invention will be understood better and will become more clearly apparent from reading the description given below with reference to the appended figures, which are given by way of example and in which:

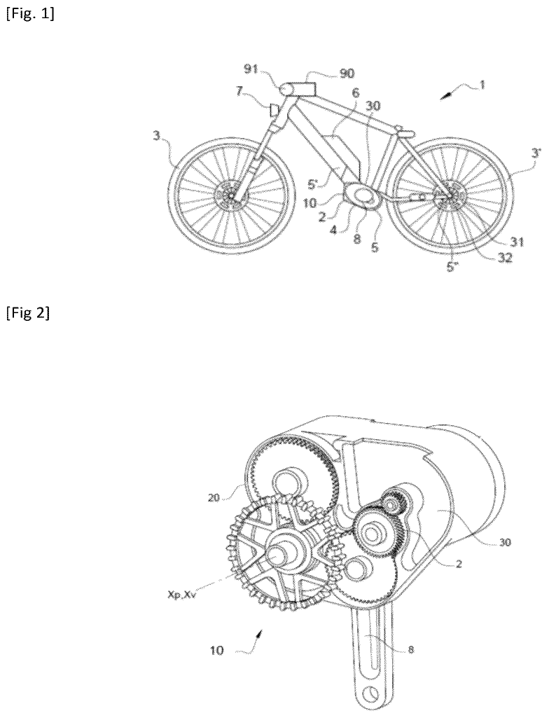

FIG. 1 is a view of a mobility device according to one of the aspects of the invention,

FIG. 2 illustrates the transmission assembly of the mobility device of FIG. 1,

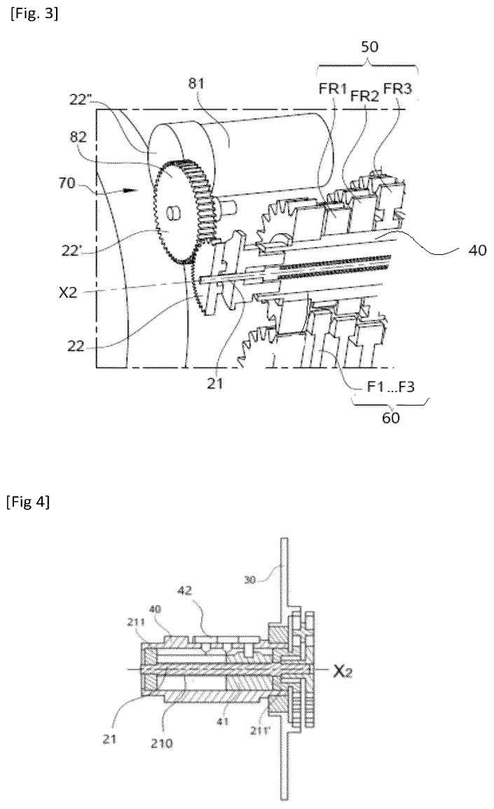

FIG. 3 illustrates a cross-sectional view of part of the transmission assembly according to one embodiment of the invention,

FIG. 4 illustrates a cross-sectional view of another part of the transmission assembly according to one embodiment of the invention,

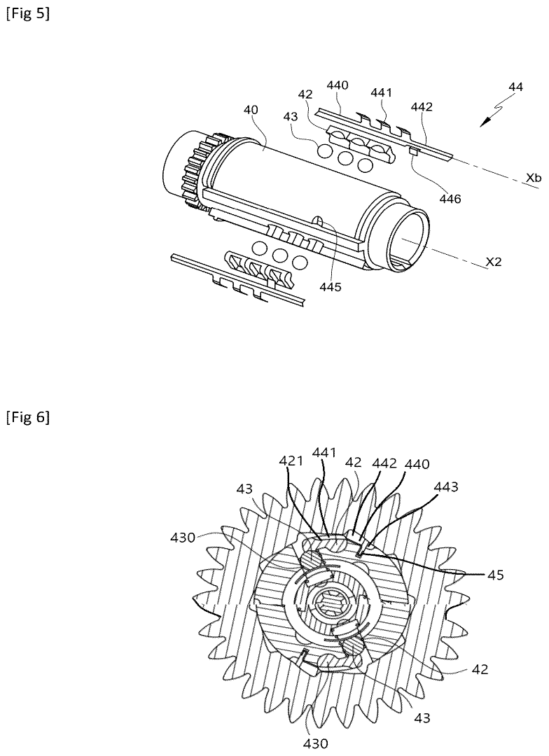

FIG. 5 is a view in elevation of the system of pawls according to the invention,

FIG. 6 is a cross-sectional view of a system of pawls according to the invention,

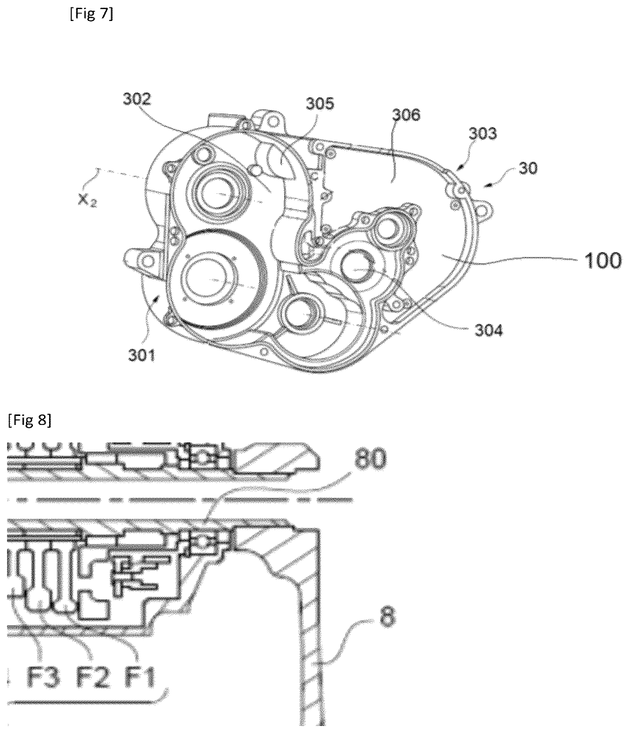

FIG. 7 is a view in elevation of the closure system that closes the housing of the gearshift device according to the invention according to another embodiment of the invention,

FIG. 8 is a cross-sectional view of part of the output shaft.

FIG. 1 illustrates a mobility device 1 according to one of the aspects of the invention. The device 1 here is an electrically assisted bicycle comprising an electric motor 2. The electric motor 2 is designed to provide some of the propulsion of the device.

The bicycle comprises at least two wheels 3, 3′ to which a motive force is supplied via two pedals turning about an axis of a crankset of axis Xp [FIG. 2] which drives the rear wheel, for example via a chain, or any other transmission means during its use.

The device 1 also comprises a control unit 4 and a plurality of sensors 5, 5′, 5″, situated for example at the crankset, on the frame of the bicycle or at a wheel 3, 3′.

The device 1 shown here also comprises an energy storage device in the form of a battery 6, a lighting system 7, a crankset 8 of axis Xp [FIG. 2], a location and/or navigation system 90 and a human-machine interface system 91 notably comprising a touchscreen able to display information for and/or to take into account the requirements of said user. The human-machine interface system 91 is in particular connected to the location system 90 and serves as navigation interface. The invention is not limited to a particular human-machine interface system, and may comprise any system known to a person skilled in the art.

The wheels 3, 3′ are provided with a brake system 31, notably comprising disc brakes 32. The device 1 has a transmission assembly 10, illustrated in [FIG. 2]. The transmission assembly 10 comprises an automatic gearshift device 20 according to the invention and the electric motor 2 for supplying some of the power for propelling the device 1.

According to a first variant of the invention, the device has 3 gears.

According to one embodiment of the invention, the transmission assembly 10 is at least in part housed in a housing 30 here positioned at the crankset 8, the axis Xp of which is coincident with the output axis Xᵥ of the gearshift device 20.

In the context of the invention, the gearshift device 20 illustrated in [FIG. 2] to [FIG. 4] contains three gear ratios.

According to one embodiment of the invention, the gearshift device 20 illustrated in [FIG. 3] and [FIG. 4] has 3 gear ratios ranging between a first gear ratio called 1st gear and a higher gear ratio called 3rd gear.

According to one embodiment of this first variant, the gearshift device 20 comprises a series 60 of three output pinions of axis X, namely pinions referenced F₁ to F₃, rotating as one with a hollow shaft 80 [FIG. 8], and a series 50 of three input pinions of axis X, referenced FR₁ to FR₃, configured to turn freely about the selection shaft 40.

According to one embodiment of the invention, the selection shaft 40 illustrated in [FIG. 3] to [FIG. 6] houses a shuttle 41 surrounding a worm 21 of the gearshift device 20.

The device 1 according to the invention comprises a gearshift actuator 70 configured to move the shuttle 41 along the worm 21 by a helical kinematic connection, between 3 positions from P₁ to P₃ and to engage a selected gear ratio.

According to one embodiment of the invention, the gearshift actuator 70 comprises electrical means for moving the shuttle 41, in the form of a reduction gearset. This reduction gearset comprises a motor 81 and a reduction gear 82.

According to one embodiment of the invention, the reduction gearset also comprises a pinion 22 on the axis of the worm 21, an intermediate pinion 22′ and a pinion 22′″ on the axis Xm of the motor 81. The toothsets of the pinions 22, 22′, 22″ may be straight-cut teeth as illustrated or helical teeth in a variant which is not illustrated.

The rotational guidance of the worm 21 is, for example, ensured by means of rolling bearings at each of its ends.

According to one embodiment of the invention, the shuttle 41 is configured such that, as it moves, it is positioned below the pinion of the selected gear ratio and engages this gear ratio. According to one embodiment of the invention, the gearshift device 20 comprises a series of three pawls positioned one after another along the longitudinal axis X2 of the selection shaft 40.

According to one embodiment of the invention, the gearshift device 20 comprises at least one series of three pawls positioned one after another along the longitudinal axis X2 of the selection shaft 40.

According to one embodiment of the invention, the gearshift device 20 comprises two series of three pawls positioned one after another along the longitudinal axis X2 of the selection shaft 40.

According to one embodiment of the invention, the series are arranged 180 degrees from each other around the selection shaft 40. This limits the number of parts compared to the prior art. The pawls 42 have a shape configured to collaborate with the input pinions FRi.

The pawls 42 are housed in recesses 420 formed on the selection shaft 40. Each pawl 42 is associated with a lifter device, and for example a ball 43, visible in [FIG. 5] and [FIG. 6], housed in a drilling 430 in the inner shaft and protruding into the inside of the inner shaft, and positioned beneath each pawl 42 so as to be able to lift it via the shuttle 41.

Thus, during a gearshift, the worm 21 is rotated by the gearshift actuator 70 causing axial movement of the nut 210 of the worm 21 which drives the shuttle 41, the shuttle 41 is positioned under the input pinion FR; corresponding to the selected gear ratio i, which is then blocked against rotating by one of the pawls 42, and meshes with the corresponding output pinion.

In the context of the invention, in order to hold the pawls 42 in place in their housing, the gearshift system comprises at least one radial blocking system 44 formed as a single piece. What that means to say is a system 44 that keeps the pawls 42 pressed into their housing, while at the same time allowing them to be lifted by the ball 43 and the shuttle 41. The radial blocking system 44 is formed in one piece. That makes it easier to fit and to manufacture and limits costs.

According to one embodiment of the invention, the blocking system 44 comprises a longitudinal flat part 440.

According to one embodiment of the invention, the system 44 comprises three tabs 441, in the case of a three-geared device.

According to one embodiment of the invention, the tabs 441 are formed starting from a first edge 442, parallel to the axis Xb of the blocking system 44, of the flat part 440 and are oriented perpendicular to the axis Xb of the blocking system 44. The rotational-blocking system 44 thus forms a comb with flattened and separated teeth.

According to one embodiment of the invention, the flat part 440 is inserted, via a second edge 443, opposite to the edge 442 at which the tabs 441 are situated, into a longitudinal slot 45, parallel to the axis of the shaft, formed in the selection shaft 40.

According to one embodiment of the invention, this second edge 443 is bent over toward the shaft 40 so as to be inserted into the slot 45.

The blocking system 44 is arranged on the selection shaft 40 in such a way that each tab 441 is positioned over a pawl 42.

According to one embodiment of the invention, each pawl 42 comprises a recess 421 the shape of which compliments that of the tab 441 so that the tab 441 is housed in the recess 421 and does not move when the pawl is immobilized.

According to one embodiment of the invention, the rotational-blocking system 44 comprises a positioning tab 446. This positioning tab 446 is positioned on the second edge 443 that is inserted into the slot 45. This tab 446 collaborates with an additional housing 445 of a shape that compliments that of the positioning tab 446 and that is formed in the selection shaft 40. This positioning tab 446 allows the tabs 441 of the device to be centred over the pawls 42.

The rotational-blocking system 44 thus applies to each pawl 42 a pressure, or pressing force, that is enough to block the pawl 42 in the housing 421 while allowing it to be lifted by the shuttle 41.

According to one embodiment of the invention, the gearshift system comprises at least two rotational-blocking systems 44 positioned in such a way as to block two series of pawls.

Thus, when the mobility device is in operation, the shuttle 41 is able to select the chosen gear ratio and this will engage an input pinion FRi via a pawl 42 and be blocked against rotation by virtue of the rotational-blocking system 44.

The input pinion FRi then meshes with an output pinion Fi.

If the device 1 is running in a gear ratio i, without a change of gear, the worm 21 does not turn.

During a change in gear ratio, the worm 21 is driven in rotation by the gearshift actuator 70 causing the axial movement of the nut 210 of the worm 21 which drives the shuttle 41 and thus allows the gearshift. The pivot connection thus implemented converts the rotational movement of the worm 21 into translational movement of the shuttle 41.

According to one embodiment of the invention, a limit stop 211, 211′ limits the movement of the shuttle 41 at each end. According to another embodiment of the invention, the movement of the shuttle is controlled by a position sensor.

In an embodiment which has not been illustrated, the shuttle 41 is able to adopt a position referred to as the neutral position P0 in which no gear ratio is engaged.

The assembly is placed in a casing, a first face 100 of which is illustrated in [FIG. 7].

The casing 30 has a case 301 that delimits a first housing 302 arranged so as to accommodate the gearsets of the gearshift device 20. The case 301 also delimits multiple second housings that are separate from one another. The housings 303, 304, 305 and 306 are configured so as to accommodate respectively the electric motor 2, the reduction gear 82, the gearshift actuator 70 and the control unit 4 of the mobility device. The second housings are preferably sealed, in particular the one which is configured so as to contain the control unit 4. This first face 100 is closed by a closure system of the cap or cover type.

The scope of the present invention is not limited to the details given above and allows embodiments in numerous other specific forms without moving away from the field of application of the invention. Consequently, the present embodiments should be considered by way of illustration, and may be modified without, however, departing from the scope defined by the claims.

1. Gearshift device for a mobility device, comprising:
a selection shaft in which there are housed a shuttle and a worm,
three input pinions configured so as to turn freely around the selection shaft,
three output pinions that rotate as one with a hollow shaft,
a gearshift actuator arranged so as to displace the shuttle along the worm between three positions and to engage a selected gear ratio,
wherein it comprises at least a series of three pawls positioned one after another along the longitudinal axis of the selection shaft, each pawl being associated with a lifter device allowing the pawl to be lifted by the shuttle and engage the gear ratio selected via the input and output pinions.

2. Gearshift device according to claim 1, the gearshift device comprising two series of three pawls positioned one after another along the longitudinal axis of the selection shaft.

3. Gearshift device according to claim 2, wherein the series of pawls are arranged 180 degrees from each other around the selection shaft.

4. Gearshift device according to claim 1, comprising a radial blocking system, formed as a single piece, to hold all of the pawls in place on the selection shaft.

5. Gearshift device according to claim 4, wherein the blocking system is formed of a longitudinal flat part from which there extend at three tabs, each of the tabs being positioned above one of the pawls.

6. Gearshift device according to claim 1, comprising three input pinions and output pinions, three pawls and three tabs.

7. Gearshift device according to claim 1, wherein the radial blocking system comprises a positioning tab.

8. Mobility device, notably an electrically assisted mobility device, having a gearshift device according to claim 1.

9. Mobility device according to claim 8, wherein the device is an electrically assisted bicycle.

10. Gearshift device according to claim 2, comprising a radial blocking system, formed as a single piece, to hold all of the pawls in place on the selection shaft.

11. Gearshift device according to claim 2, comprising three input pinions and output pinions, three pawls and three tabs.

12. Gearshift device according to claim 2, wherein the radial blocking system comprises a positioning tab.

13. Mobility device, notably an electrically assisted mobility device, having a gearshift device according to claim 2.

14. Gearshift device according to claim 3, comprising a radial blocking system, formed as a single piece, to hold all of the pawls in place on the selection shaft.

15. Gearshift device according to claim 3, comprising three input pinions and output pinions, three pawls and three tabs.

16. Gearshift device according to claim 3, wherein the radial blocking system comprises a positioning tab.

17. Mobility device, notably an electrically assisted mobility device, having a gearshift device according to claim 3.

18. Gearshift device according to claim 4, comprising three input pinions and output pinions, three pawls and three tabs.

19. Gearshift device according to claim 4, wherein the radial blocking system comprises a positioning tab.

20. Mobility device, notably an electrically assisted mobility device, having a gearshift device according to claim 4.
